(19) United States
(12) Patent Application Publication
(10) Pub. No.: US 2008/0115862 A1
(43) Pub. Date: May 22, 2008

(54) Method for thermal cutting

(76) Inventor: Wolfgang Danzer, Dorfen (DE)

Correspondence Address: THE BOC GROUP, INC., 575 MOUNTAIN AVENUE, MURRAY HILL, NJ, 07974-2064, US

(21) Appl. No.: 11/975,849

(22) Filed: Oct. 22, 2007

(30) Foreign Application Priority Data
Oct. 5, 2006 (DE) 102006051125.5
Jan. 4, 2007 (EP) 07000136.7

(51) Int. Cl. B23K 9/013; B23K 10/00; B23K 7/00

(52) U.S. Cl. 148/197; 219/121.44; 219/121.72; 219/121.39; 219/121.67; 266/48

(57) ABSTRACT

The invention relates to a method for thermal cutting, wherein a cutting gas is piped into a cutting nozzle and guided on to a work piece to be processed by means of the cutting nozzle. According to the invention the cutting gas is at least reduced in a periodically repetitive manner wherein the time in which the cutting gas is guided onto the work piece in an undiminished manner is shorter than half of a period. In addition the invention relates to a corresponding device with a valve.

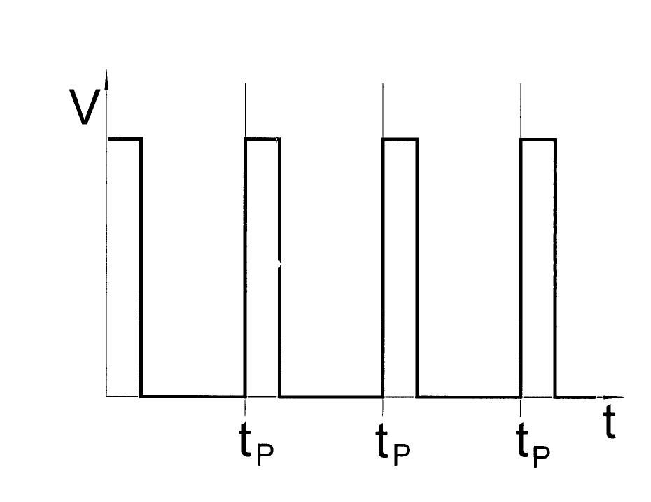

### BACKGROUND OF THE INVENTION

The present invention relates to a method for thermal cutting, wherein a cutting gas is piped into a cutting nozzle and by means of the cutting nozzle is guided to a work piece to be processed. In addition, the invention relates to a device for thermal cutting comprising a cutting gas supply pipe leading to a cutting gas nozzle and a valve provided in the cutting gas supply pipe.

During thermal cutting work pieces are cut in that energy is supplied to the place to be cut, through which material at the processing location is removed and this material is finally driven out with the help of a gas jet, the so-called cutting jet. Of advantage here is that the tool, the cutting jet, does not become blunt and that hardly any force is exerted on the work piece to be cut. There are different possibilities of energy supply so that several thermal cutting methods exist.

With flame cutting the material is heated to ignition temperature with a fuel gas-oxygen flame and burnt in the cutting oxygen flow or in a cutting gas flow containing oxygen. By burning the material in the cutting oxygen energy is supplied to the cutting process in addition to the flame. The slag which is created through the burning and the melted material are driven out with the kinetic energy of the oxygen jet.

Plasma cutting is a melting process where a metallic material is melted through a plasma jet and blown from the cutting groove. During plasma cutting the required energy for melting the material in the cutting groove is supplied via a constricted arc which is surrounded by a plasma gas. Usually argon, nitrogen and hydrogen and mixtures thereof are employed as plasma gas. Oxygen is added to the plasma gas in some cases wherein the oxygen can lead to oxidation with the material, bringing in additional energy as a result. Compressed air as plasma gas is also employed. If oxygen or gas mixtures containing oxygen are used an electrode has to be used that has an adequate lifespan also in the presence of oxygen. Mainly because of this, but also for other reasons, two gas flows are sometimes employed of which the first envelopes the electrode in a contacting manner and the second gas flow encases the first one. In plasma cutting the material is blown from the cutting groove by the gas.

During laser beam cutting a laser beam is utilised as cutting tool. To this end the laser beam is steered to the desired point for the purpose of which the laser beam is focused onto the surface of the work piece to be cut or the interior of the work piece with a lens in the cutting head, wherein the high energy density quickly heats the material to be cut. During laser beam melt cutting the material is heated to melting temperature and with laser sublimation cutting to evaporation temperature. During laser beam flame cutting oxygen is piped to the location to be cut so that, as is necessary for flame cutting, additional energy is introduced through the burning of the oxygen with the material. To this end the laser beam continually heats the work piece at the processing point to ignition temperature so that burning of the work piece material with the cutting oxygen can take place. The melted material during laser beam cutting is driven from the cutting groove with the cutting gas, wherein during laser beam flame cutting the cutting oxygen jet in addition to the melted material also drives out the developing slag. During laser beam flame cutting, oxygen is used as the cutting gas while nitrogen, argon and/or helium are otherwise used. Compressed air is also employed. The laser beam is an ideal tool for cutting metal and non-metal materials of low thicknesses. However, with increasing material thickness the cutting speed of the laser beam is severely reduced. For example, during laser beam flame cutting, plates with a thickness of approximately 2 mm can be cut six times faster than plates with a thickness of approximately 15 mm.

During laser beam cutting the cutting speed can be increased in that the cutting gas is supplied in a turbulent flow. From the publication DE 43 36 010 A1 for example a laser cutting device is known where a main auxiliary gas and a secondary auxiliary gas are supplied by means of a processing head so that the gas flow as a whole is in a turbulent state of flow. In addition it is known from DE 10 2004 052 323 A1 that the cutting speed or the plate thickness to be cut can be increased through a modulated movement of the cutting head. This can also be achieved through a modulation of laser output and gas pressure which is not explained in more detail.

For flame cutting a method is known from the publication DE 101 48 168 A1 where the cutting gas flows in a turbulent manner in the cutting groove. Here, the turbulence of the gas flow is created through pulsing with a valve or through an additional discontinuous gas flow.

With all thermal cutting methods however, problems occur in terms of cut quality and the cutting operations are susceptible to instabilities which result in quality fluctuations and in non-reproducible cutting results. These difficulties are present in a particularly pronounced manner with high cutting speeds and with thick plates.

### SUMMARY OF THE INVENTION

Based on the disadvantages and shortcomings presented above and appreciating the outlined references, the present invention is based on the object of further developing a method and a device for the thermal cutting of the kind mentioned at the outset so that the quality of the cuts, more preferably the cut edges and the stability of the cutting process are improved more preferably also at high cutting speeds and with thick plates.

This object is realized through a method for thermal cutting, wherein a cutting gas is piped into a cutting nozzle and guided onto a work piece to be processed by means of the cutting nozzle, characterized in that, the cutting gas is at least reduced in a periodically repetitive manner, wherein the time in which the cutting gas is guided onto the work piece in an undiminished manner is shorter than half of a period and through a device for the thermal cutting comprising a cutting gas supply leading to a cutting gas nozzle and a valve provided in the cutting gas supply, characterized in that the valve is connected with a control unit which opens and at least partly closes the valve in a periodically repetitive manner wherein the control unit opens the valve for a maximum of half the period. Advantageous designs and suitable further developments of the present invention are characterized in the in respective sub-claims.

Thus, the present invention is based on the premise that cutting gas is not evenly guided against the work piece as is customary at present but that clocking as it were is performed and the cutting gas is guided towards the work piece according to a periodically repeating pattern. However the clocking is irregular. Within one period the cutting gas is steered onto the work piece in an undiminished manner for the shorter time and reduced for the longer time. For the cutting gas pressure which is present at the processing point this means that it is not constant but subject to a temporal change according to the following: the change of the cutting gas pressure takes place periodically, i.e. it follows a recurring time pattern. Within one period, i.e. within the time span until the pattern starts to repeat itself, there is a maximum value for the cutting gas pressure which is obtained when the cutting gas flows from the cutting nozzle in an undiminished manner. This maximum value for the cutting gas pressure however is applied for less then half the period.

With the method according to the invention a very high quality for cuts and cut edges is achieved. In addition, the process stability is considerably increased compared with the conventional thermal cutting methods so that quality fluctuations are prevented and reproducibility increases. These advantages appear also and in a particularly pronounced manner at high cutting speeds. The increase of the process stability and also the improvement in terms of the cut edges are attributable to the clocking of the cutting gas according to the invention. The stated clocking of the cutting gas brings about that the driving-out of the liquid material from the cutting groove takes place more briskly and evenly than with cutting gas that remains uniform. Because of the improvement of the process of driving-out which comes with the invention a clear increase of the cutting speed without quality losses is also possible with the method according to the invention. Here it is of decisive importance that clocking takes place according to the invention.

In a preferred design the cutting gas is switched off and on before or in the cutting nozzle. Thus, the cutting gas is switched on for less than half the period and switched off for the remaining time of the period. The advantages of the invention however become apparent very clearly even if the cutting gas is not switched off but the cutting gas rate is merely reduced. A reduction of the cutting gas rate by half, even by a third, is sufficient for this. When the cutting gas is switched off or reduced the cutting gas pressure at the processing point drops as a consequence of the switching-off or reduction. Lowering of the cutting gas pressure to zero value however is not necessary for obtaining the advantages of the invention. Thus, the cutting gas pressure within the scope of the invention in an advantageous manner drops to values which are approximately around 10 to 50% of the maximum pressure.

It transpired within the scope of the invention that the described clocking is of advantage for all thermal cutting methods. Clocking supports the process of driving-out in an advantageous manner with all versions. With the thermal cutting methods, where work piece material is burnt in the cutting oxygen or in the cutting gas containing oxygen, not only the driving-out of the liquid material is promoted in an advantageous manner as with the remaining cutting methods, but also the driving-out of the developing slag. In a surprising manner driving-out of the liquid material is improved with all thermal cutting methods by the use of clocking according to the invention.

The advantages manifest themselves in a particularly emphasised manner if the time in which the cutting gas is guided towards the work piece in an undiminished manner is shorter than a third, preferentially shorter than a quarter, and very preferably shorter than a fifth of the period. The advantages manifest themselves up to times for undiminished guiding which are around one tenth of the period. Even at a time of one twentieth the advantages according to the invention are still noticeable.

The advantages of the invention manifest themselves in a particular manner if the period for the recurring time change lies between 0.5 and 100 Hz, preferentially between 1 and 50 Hz and very preferably between 3 and 20 Hz. It was shown that the advantages according to the invention are obtained more preferably if the pattern in this cycle is repeated.

In a particularly preferential development of the invention the cutting gas is clocked by means of at least one valve. Another possibility is to clog the cutting gas through an additional gas flow which is switched on in addition to the first cutting gas flow at times and which assumes the clocking of the cutting gas. If the cutting gas is switched off and on with a valve the valve is suitably opened or closed. If the cutting gas rate is only reduced it is possible not to fully close the valve or, which is simpler in the embodiment, a bypass is placed around the valve through which a lesser gas rate flows when the valve is closed.

Particularly preferentially a magnetic or piezoelectric valve is used for this. Magnetic and piezoelectric valves can be very favourably controlled and are therefore suitable in a particularly emphasised manner for the cutting according to the invention.

As cutting gas, oxygen and/or hydrogen and/or nitrogen and/or argon and/or helium and/or at least one mixture of at least two of the aforementioned gases can be employed for example. Compressed air can also be used. The advantages of the invention are also evident when using other gases so that in the selection of the cutting gas the requirements of material to be processed and cutting method are of prime importance.

The advantages according to the invention manifest themselves more preferably during cutting of thick plates. When cutting thick plates, i.e. plates with a thickness of 3 mm and more, and when cutting very thick plates with thicknesses of more than 5 mm, the process of driving-out is of special importance since the amount of material to be driven-out also increases with increasing thickness. Thus the advantages of the invention manifest themselves in a particular manner with thick plates.

In the device according to the invention the valve is connected with a control unit which repetitively opens and at least partly closes the valve periodically, wherein the control unit opens the valve for a maximum of half of the period. Preferably the valve closes completely. With this device it is possible to achieve the aforementioned advantages.

Both the method for thermal cutting according to the type explained above and the device for the thermal cutting according to the type explained above offer the advantage that the cutting process is particularly stable and good quality cuts, more preferably neat cut edges, are achieved even at high cutting speeds.

### BRIEF DESCRIPTION OF THE DRAWINGS

The FIGURE describes a chart whereby the switching of the valve through which cutting gas flows is measured versus time.

### DETAILED DESCRIPTION OF THE INVENTION

For quick and burr-free flame cutting with flame or laser beam oxygen with a high purity is preferentially employed. With the flame cutting methods an advantage in addition to the advantages in terms of driving-out of slag and melted material is obtained. Here, the cutting groove can cool down during the cutting process since, because of the absence of the cutting gas, burning of the oxygen is reduced. This improves quality and appearance of the cut groove since the undesirable oxidation layer on the cut edges is reduced. The risk of thermal distortion is also reduced and the amount of slag diminishes. Despite the reduction of the oxygen rate however this is adequate for introducing sufficient energy via the burning so that very fast cutting is possible.

With laser melt cutting the driving-out process of the melted material is of major importance so that the advantages according to the invention manifest themselves. With laser sublimation cutting the material at the place to be cut is primarily evaporated but liquid material develops as well. For a stable cutting process it is important that the liquid material is driven out so that the advantages of the invention also manifest themselves here.

With plasma cutting the melted material and, with plasma cutting with oxidation, slag also has to be driven-out in addition to the melted material. The advantages which accompany the invention also manifest themselves here. If for plasma cutting an inner plasma gas jet and an outer secondary jet are employed only one of the two gas jets can be clocked.

With all thermal cutting methods the process of driving-out is positively promoted through the clocking according to the invention. This is likely to be due to the impulse exerted on the liquid material through the increase of the cutting gas pressure. In addition it can be of advantage that it becomes possible to select a very high value for the maximum cutting gas pressure since this likewise improves the process of driving-out the material. By improving the driving-out process the cutting process as a whole takes place in a more stable manner so that cutting can be very favourably handled and the cutting results can be very well reproduced. An increase of the cutting speed is also possible without the cutting process losing stability. This applies also and more preferably during the cutting of thick plates where the amounts of material to be driven-out happen to be particularly large.

The clocking stated with the invention will now be explained in more detail by means of the FIGURE. To this end, the switching of the valve against the time is shown in the FIGURE. With the exemplary valve switching clocking is obtained which follows the advantageous development where the cutting gas is switched on for less than half of the period. To this end, the time t is plotted in the FIGURE toward the top of the switching of the valve V and to the right. The time t shows the periodic structure wherein one period has the time t_{P} i.e. after the time t_{P} the sequence is repeated. For the valve switching V an upper value manifest itself for the shorter time span within the period t_{P} which means that the valve is opened. For the long time span the value of valve switching is at zero, i.e. the valve is closed. For the cutting gas pressure at the processing point this means: at the start of the period the valve is opened and the maximum cutting gas rate is directed to the processing point. As a result the cutting gas pressure rises very quickly to its maximum value. While the valve is now open this maximum cutting gas pressure is present. Once the valve has been closed the cutting gas pressure drops to a minimum value. However, this minimum value preferentially is above the zero value so that cutting gas is continuously present at the processing point and complete breaking-off of the cutting process is avoided. From this minimum value the cutting gas pressure again rises to its maximum value as soon as the valve is opened again and a new cycle commences.

The advantages of the invention manifest themselves with all methods of thermal cutting, i.e. with flame cutting, with plasma cutting and with laser cutting.

We claim:

1. A method for thermal cutting, wherein a cutting gas is piped into a cutting nozzle and guided onto a work piece to be processed by means of the cutting nozzle, characterized in that the cutting gas is at least reduced in a periodically repetitive manner, wherein the time in which the cutting gas is guided onto the work piece in an undiminished manner is shorter than half of a period.

2. The method according to claim 1, characterized in that the cutting gas before or in the cutting nozzle is switched off in a periodically repetitive manner wherein the time in which the cutting gas is guided towards the work piece is shorter than half of the period.

3. The method according to claim 1, characterized in that thermal cutting is performed by means of the method selected from the group consisting of flame cutting, laser cutting and plasma cutting.

4. The method according to claim 1, characterized in that the time in which the cutting gas flows against the work piece in an undiminished manner is shorter than one third, preferentially shorter than a quarter and very preferably shorter than one fifth of the period.

5. The method according to claim 1, characterized in that the period for the temporal repetition lies between 0.5 and 100 Hz.

6. The method according to claim 1, characterized in that the period for the temporal repetition lies between 1 and 50 Hz.

7. The method according to claim 1, characterized in that the period for the temporal repetition lies between 3 and 20 Hz.

8. The method according to claim 1, characterized in that the cutting gas is reduced or switched off mechanically.

9. The method according to claim 8 wherein said cutting gas is reduced or switched off mechanically by at least one valve.

10. The method according to claim 8, characterized in that a magnetic or piezoelectric valve is employed.

11. The method according to claim 1, characterized in that said cutting gas is selected from the group consisting of oxygen, nitrogen, argon, hydrogen and a mixture of these gases.

12. The method according to claim 1, characterized in that thick plates are cut.

13. A device for the thermal cutting comprising a cutting gas supply leading to a cutting gas nozzle and a valve provided in the cutting gas supply, characterized in that the valve is connected with a control unit which opens and at least partly closes the valve in a periodically repetitive manner wherein the control unit opens the valve for a maximum of half the period.

14. The device according to claim 13, characterized in that the control unit of the valve opens for a third, preferentially for a maximum of a quarter and very preferably for a maximum of a fifth of the period.

15. The device according to claim 13, characterized in that the periodic repetition has a frequency of 0.5 and 100 Hz.

16. The device according to claim 13, characterized in that the periodic repetition has a frequency of 1 and 50 Hz.

17. The device according to claim 13, characterized in that the periodic repetition has a frequency of 3 and 20 Hz.

18. The device according to claim 13, characterized in that the valve is a magnetic or piezoelectric valve.
